(19) United States
(12) Patent Application Publication
(10) Pub. No.: US 2015/0232667 A1
(43) Pub. Date: Aug. 20, 2015

(54) NOVEL POWDER INJECTION MOULDING FEEDSTOCK SYSTEM AND TECHNOLOGY BASED ON DUAL MAIN BINDER CONCEPT, METHODS AND USES

(71) Applicants: Robert Pompe, Molndal (SE); Weiru Zhang, Beijing (CN); Feng Sun, Beijing (CN); Tengfei Wang, Beijing (CN); Zhe Zhang, Beijing (CN); Jingliang Zou, Beijing (CN)

(72) Inventors: Robert Pompe, Molndal (SE); Weiru Zhang, Beijing (CN); Feng Sun, Beijing (CN); Tengfei Wang, Beijing (CN); Zhe Zhang, Beijing (CN); Jingliang Zou, Beijing (CN)

(21) Appl. No.: 14/568,139

(22) Filed: Dec. 12, 2014

Related U.S. Application Data
(60) Provisional application No. 61/929,018, filed on Jan. 18, 2014.

(51) Int. Cl. C08L 91/06; B22F 1/00

(52) U.S. Cl. CPC C08L 91/06; B22F 1/0059

(57) ABSTRACT

The present invention belongs to the field of technology known as powder injection moulding. It includes producing a part by powder injection moulding at low to high injection pressure and it discloses a novel binder system for optimized feedstock design. The primary subject matter of the invention resides in introducing a secondary main binder into the feedstock binder composition, meeting, simultaneously, the five (5) following criteria: partially soluble in the primary binder, soluble in water, thermally evaporable, possessing a dispersant functionality and increasing the viscosity at near zero feedstock shear rate. In addition to this binder, the feedstock may contain a small fraction of another dispersant and a back-bone polymer when needed, depending on the type of powder material used for the feedstock. Based on the main modes of binder removal (thermal or water extraction) this novel binder system is denominated as Te-Wex™ system. Using this binder concept feedstocks with a wide variety of powders, including alumina, zirconia, silicon nitride, stainless steel and low-alloyed steel could be prepared and subsequently injected using the MPIM (Medium pressure Powder Injection Moulding) technique into one- or multiple cavity tools to make parts of variable thickness. These parts could be debinded either by partial water extraction and/or thermal evaporation and sintered to final density of over 99 vol % of the respective theoretical values.

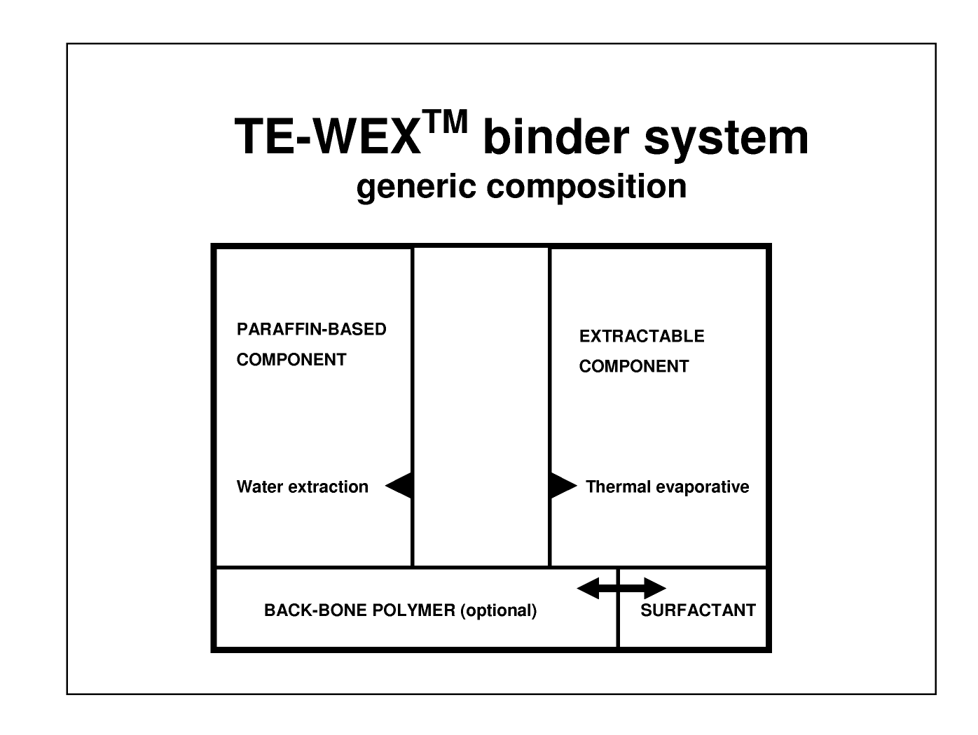

### REFERENCES CITED

1. R. Pompe and J Brandt, “GOCERAMs MEDPIMOULD technology offers cost-effective PIM production”, Metal Powder Rep., June 2001, p.14
2. Izidor Antonson, Jesper Brandt, Robert Pompe, Method and means for producing a ceramic or metallic product for sintering, U.S. Pat. No. 6,066,274 A/EP0871555B1/WO/1997001408A1
3. Korbee, Roland, Method for producing a powder injection moulded part, WO/2011/016718; NL2010/050406
4. Miao Yong Cao, Chan I. Chung, Solid polymer solution binders for shaping of finely-divided inert particles, U.S. Pat. No. 5,665,289

### FIELD OF THE INVENTION

The present invention belongs to the field of technology known as powder injection moulding. It includes producing a part by powder injection moulding at low to high injection pressure, comprising the steps of: A) mixing powder to be sintered with a binder to provide a feedstock, B) injection moulding the feedstock to form a moulded part, C) debinding the moulded part, and D) sintering the debinded moulded part. The invention is particularly involved with developing a novel binder system and the removal of the same by thermal or liquid, preferably water, extraction, according to the invention. The invention further relates to a powder injection moulded part obtained by the method according to the invention.

### OUTLINE OF RELATED ART

The powder injection moulding techniques (PIM) are based on highly loaded organic binder-powder feedstocks which are injected into a mould tool with one or multiple cavities. The productivity is high on the moulding side but the subsequent binder removal is the bottle-neck in terms of time, quality and thus productivity. To a different extend, there are also environmental issues about the organic residues and waste generated as a consequence of the different binder removal processes. PIM is an attractive process technology to make complex form shaped parts, comprising the following steps: A) mixing powder to be sintered with a binder to provide a feedstock, B) injection moulding the feedstock to form a moulded part, C) debinding the moulded part, and D) sintering the debinded moulded part. Using such a PIM process, metal, glass, or ceramic powder, is mixed with a binder (step A), also referred to as carrier, wherein said binder primarily facilitates injection moulding of the powder. Depending mainly on the injection pressure needed there are three types of PIM techniques on the current market: Low Pressure Injection Moulding (LPIM), Medium Pressure Injection Moulding (MPIM) and High Pressure Injection Moulding (HPIM), the later using modified plastic IM machines.

In HPIM, a commonly used binder is formed by (a copolymer of)poly(oxymethylene) (POM), such as the acetal polyoxymethylene copolymer marketed under the trade name Ultraform or as ready-to use feedstocks (Catamold®) available from BASF. Moulding said mixture into a desired shape (step B) will lead to a bound moulded part, also called a “green body”.

Subsequently, the polymer binder is removed by means of a corrosive solvent, typically nitric acid, commonly at a temperature between approximately 110 and 120° C. (step C). Thereafter, the remaining shaped porous moulded part is sintered to produce the desired shaped article (step D).

During this sintering step the moulded part will shrink without affecting the shape of the moulded part. The powder particles will fuse together and the open space between the powder particles disappears. Hence, during sintering the density of the product increases and the product shrinks. The sintering step is commonly completed when the product has reached a density of around 99 volume % of the solid of which the powder is made. Although the mentioned HPIM process is very suitable for forming complex and intricate shaped moulded parts, it also suffers from several drawbacks. A major drawback is the required use of the corrosive solvent, typically nitric acid, for chemically decomposing the binding polymer POM. At increased temperature nitric acid will be converted into toxic nitrogen oxides and/or produce formaldehyde which is undesirable.

Thermally decomposing the polymer-based binder, instead of chemically decomposing, is only possible at relatively low temperatures (exceeding room temperature). However, this would result in an unacceptably slow debinding process. Thermal decomposition at higher temperatures is difficult to control as it leads to generation of gaseous decomposition products, causing build up of pressure inside the product. Damage caused by deformation and/or fracture can easily result, hence, thermally decomposing the binder is not a viable option to remove the polymer binder.

U.S. Pat. No. 5,665,289 discloses an equivalent HPIM process as described above, wherein as binder use is made of a mixture of a low molecular weight organic material and a polymer. A characteristic of this mixture is that the polymer and the organic compound form a solid solution below the melting temperature of the low molecular weight compound, which means that upon cooling of the molten binder, the mixture remains homogeneous and will solidify into a solid solution. The described advantage of using this particular binder is that removal of the binder is carried out in two steps: in the first step the low molecular weight material is removed by extraction, while in a subsequent second step the polymer is removed.

The extraction of the low molecular weight material is carried out below the melting point of the low molecular weight, as a result of which the entire binder (i.e. both the low molecular weight material and the polymer) remain solid during the first debinding step. Therefore deformation caused by softening will not likely occur and the part will retain its shape and will not deform. A further described advantage of using this particular binder is that because the binder is made of a solid solution of an organic compound and the polymer, the binder is very homogeneous at a microscopic scale, as a result of which it is alleged that the material remains homogeneous during and after extraction of the low molecular weight compound counteracting the molded product to deform during debinding. Since the debinding step will be performed at a relatively low temperature in order to prevent softening of the binder which could lead to deformation of the molded part, the debinding process will a be relatively time-consuming process. Moreover, the formation of the solid solution disclosed requires critical attention during processing. Low molecular weight compounds will have the tendency to crystallize upon cooling. Therefore formation of a solid solution of a polymer and a low molecular weight component requires a relatively high cooling rate in order to prevent crystallization of the low molecular weight component. This will commonly not be feasible in a mould during injection moulding, especially not in the case of thick-walled products.

WO/2011/016718 (NL2010/050406) discloses a method for producing a powder injection moulded part characterized in that the binder comprises a mixture of at least one thermally decomposable polymer and at least one low molecular weight decomposable solvent that can be extracted. Use of such a binder is said to have the additional advantage of a phase separation (breaking) occurring during cooling.

Due to this phase separation within the binder, the polymer part of the binder will be left over as a sponge-like (porous) structure when the low molecular weight solvent is removed by extraction or evaporation. Since decomposition gases formed within the moulded part can freely flow out of the moulded part without deforming the moulded part, the use of a corrosive substance is no longer required to remove the binder from the moulded part which is favourable from both an economic and an ecological point of view. The binder is said to have additional advantage that the incorporation of the binding solvent in he binder reduces the viscosity of the binder and hence of the moulding mixture, and hence reducing material stresses within the moulded part. Consequently, an improved dimension stability will be obtained allowing a larger degree of freedom of design of the moulded part. What is not mentioned though is that, due to this, the green strength will be low which in particular can be a critical disadvantage for larger and/or heavy parts, sensitive to mechanical damage during handling.

Removal of the solvent may imply either physical processes like extraction or vaporization or chemical decomposition (degradation). Several types are mentioned, the removable solvent is selected from the group consisting of caprolactam, polyethylene glycol (PEG), acetanilide, benzamide, 4-hydroxyacetophenone, maleimide, and phtalimide. The application of PEG is said to be beneficiary, since PEG is biodegradable and hence environmentally friendly. The thermally decomposable polymer is selected from the group consisting of poly(oxymethylene) (POM), polyethylene (PE), polypropylene (PP), and derivates (copolymers) thereof. The surfactants chosen in the amount of 0-5 vol %, are amines and polymeric fatty acid esters, further different anionic surfactants, cationic surfactants, zwitterionic surfactants, and nonionic surfactants. Examples of anionic surfactants are surfactants based on sulfate, sulfonate or carboxylate anions. Examples of cationic surfactants are surfactants based on quatemary ammonium cations. Examples of zwitterionic surfactants are dodecyl betaine, cocamidopropyl betaine and coco amphoglycinate.

Examples of nonionic surfactants are alkylpolyglucosides, fatty alcohols (cetyl alcohol and oleyl alcohol) and cocamide monoethanolamine (MEA) and cocamide diethanolamine (DEA). There are many other similar binder systems for HPIM described in the literature where almost all or a substantial part of the binder is removed by extraction, preferably in water, water being selected for environmental reasons but also due to issues of intermittent swelling of the parts to be extracted when using non-aqueous media. Frequent disadvantage of using water is extended drying time (due to the strongly polar nature of water molecules) as well as leaching out of some water-soluble components (ceramics like magnesia- or yttria-stabilized zirconia powders), surface hydrolysis (silicon nitride, aluminium nitride powders and similar) or corrosion (low-alloyed steel powders). In the last case, anti-corrosive additives are required in the extraction process. One commercially well-established HPIM binder system is from PolyMIM® with PEG-type binder as the water-extractable part and a back-bone polymer supporting the green body structure, as the thermally debindable component, respectively. In this and many similar binder system, the back-bone polymer is always necessary to hold the powder particles together after all of the water-extractable part of the binder has been removed.

In contrast to HPIM, the binder systems for LPIM and MPIM are based on wax, typically paraffin wax, as the main binder component in order to facilitate the injection at lower temperatures and pressures. The relatively lower feedstock viscosity however then requires powder embedment support during the debinding stage for most product shapes. In the case of MPIM the operating pressure is high enough to inject feedstocks of higher viscosity. Even when the binder systems used comprise mixtures of wax and back-bone polymer the powder embedment support will be needed for many parts.

The use of powder bed can be considered to add some processing complexity to the PIM production. Unlike HPIM though, the removal of the main binder components such as paraffin wax is performed mainly by thermal evaporation at lower temperatures rather then the more difficult-to-control burnout of polymer-based binder. The binder removal processing time in these cases is typically 1-2 days and longer for large parts (of 10 mm thickness and higher). This makes the LPIM and often also the MPIM methods more time-consuming compared to for instance the abovementioned HPIM method based on the BASF-type binder system. Increased solids loading of the feedstock is another key parameter as it reduces the amount of binder to be removed and decreases the shrinkage during the consolidation by sintering. Improved dispersion is the only appropriate way how to increase solids loading for a given powder-binder system because the other way of increasing the solids loading, i.e. by adding more powder to the feedstock, only increases the viscosity above the mouldability range.

Disregarding the type of PIM technology used, the binder system based on removal of all or substantial part of the soluble binder by extraction, as detailed above, will require extended process time for 1. extraction itself and 2. drying, already for parts with thickness over few millimeters. The total processing time for the step 1 and 2 can thus approach the time needed for thermal extraction.

### DESCRIPTION OF THE INVENTION AND PREFERRED EMBODIMENTS

The present invention belongs to the field of technology known as powder injection moulding. It includes producing a part by powder injection moulding at low to high injection pressure, comprising the steps of: A) mixing powder to be sintered with a binder to provide a feedstock, B) injection moulding the feedstock to form a moulded part, C) debinding the moulded part, and D) sintering the debinded moulded part. The invention is in particularly involved with a novel binder system and the removal of the same by thermal or liquid, preferably water, extraction, according to the invention. Based on the main modes of binder removal (thermal or water extraction) this novel binder system is denominated as Te-Wex™ system.

The primary subject matter of the invention resides in introducing a concept of a secondary main multifunctional binder into the feedstock binder composition, simultaneously meeting the five (5) following criteria: partially soluble in the primary binder, soluble in water, thermally evaporable, possessing a dispersant functionality and increasing the viscosity at near zero feedstock shear rate. In addition to this binder, the feedstock may contain a small fraction of another dispersant and a back-bone polymer when needed, depending on the type of powder material used for the feedstock.

### Example 1

### The General Principle

Brief description of the several features of the drawing: Reference is made to attached drawing where the principal composition of this feedstock binder is outlined. In a general embodiment, the binder is composed of

1. a dual main binder consisting of an alkane (paraffin wax)-based hydrocarbon chain compound and a Secondary Multi-Functional Binder (SMFB) and, optional,
2. a back-bone polymer and an additional dispersant. The roles of the later ones being (if necessary) to contribute to the structural integrity of the part prior to final consolidation and to further promote the dispersion of the powder and/or its specific components (such as sintering additives) in the feedstock, respectively.

As schematically outlined in the drawing and detailed below, the dual main binder composition can be changed in the direction of the black arrows: for water extractable binder system, the relative fraction of the extractable component is increased while for the thermally evaporative binder systems, the relative fraction of the paraffin-based component is increased. In the equivalent manner, the relative fractions of the back-bone polymer and the surfactant, respectively, can be changed, depending on the nature of the particular powder used for the feedstock.

The dual main binder concept (alkane such as paraffin wax+secondary multifunctional binder) is characterized by partial miscibility of these two binder components. This partial miscibility is an important feature according to this invention as it contributes to an increase of the viscosity at nearly zero shear rate of the feedstock. As a result, improved resistance to deformation in the initial stage of thermal debinding is obtained and therefore, there is no need of using powder embedment. If completely immiscible, the main binder components will suffer from poor chemical compatibility and, as a consequence, the partial volumes of these components when mixed will be larger then the total binder volume as geometrically calculated based on the rule-of-mixtures. This will lead to a risk of potentially lower attainable solids loading of the powder. On the other hand, completely miscible components will cause a slow extraction rate in water, in addition to other adverse effects like intermittent swelling during the extraction process.

The key role of the SMFB selected according to this invention is to deliver at the same time all the additional functionalities to the binder system as outlined below, thus making it more versatile for extended range of uses as detailed below.

a/ extractability by water: according to the preferred embodiment, the SMFB is selected among organic compounds soluble in water. Due to its solubility in water some of the binder can be removed by water extraction. The strategy how to remove the binder has been optimized to cut down the extraction time to 1/a minimum exposure time to water, in many cases 2-3 hours only and 2/minimum water temperature. The extraction exposure according to this invention is limited to the time necessary only to open up the pore system of the moulded parts so that the remaining binder then can be removed by thermal evaporation—as a part of the final consolidation/sintering cycle. Unlike other systems this cuts down the processing time, drying time to remove water and also decreases the risk of deleterious interaction of water with the fine powder components,
b/ dispersion: according to the preferred embodiment, the SMFB is selected among organic compounds denominated as non-ionic, i.e. those characterized by the presence of both acidic (carboxyl etc) and basic (amide etc) functional groups. Due to this feature, this binder component also contributes to the dispersion of powders in the feedstock,
c/ powder/binder compatibility: according to the preferred embodiment, the SMFB is selected among organic compounds so that the hydrocarbon chain is compatible with both hydrophilic and hydrophobic powder surface. It will thus improve the overall compatibility of the powders, also those that have not been pre-dried or pre-processed, with the binder system or its specific components such as surfactants,
d/ thermally evaporable: according to the preferred embodiment, the SMFB is selected among organic compounds to have a well-defined melting point and boiling point. In this way, it can be evaporated without any excessive break-down process of the hydrocarbon chain. In order to facilitate use of low-cost debinding furnace equipment this binder is selected to be evaporable up to maximum 300° C. All this also means it can be captured in a cold trap system and re-used,
e/ optional recovery: according to the preferred embodiment, the SMFB is selected among organic compounds so as not to pose any environmental risk if released into the sewage system. But, depending on the mode of use it may not be discharged but optionally recovered. Evaporative separation from water always forms an alternative.

The fundamental principle behind the preferred choice of SMFB is the functionality as dispersant. The dispersants are always added in small quantities to the feedstock in order to achieve improved particle dispersion. However, there are long chain non-ionic surfactants that, because of the long hydrocarbon chain, also can function as binders and, since they contain both acidic and basic groups in one molecule, they also act as surfactants—dispersants. Due to the non-ionic nature of the molecule they are also more or less soluble in water.

One preferred selection according to this invention that fulfils the above criteria and that proved to be compatible with many ceramic and metal systems is based on (but not limited to) cocamide diethanolamine, this particular one being blendable with both hydrophobic and hydrophilic media. Additional important property is that this type of binder has a well-defined melting and boiling point, the later is below 300° C. This means that this binder can be fully removed by evaporation. One well-characterized choice is based on a commercial coconut fatty acid that has carbon chain composition of C10 (5% max)+C12 (45-55%)+C14 (20-25%)+C16 (10-15%)+C18 (10-15% max, including unsaturated fatty acids). Cocamide is an amide mixture of coconut fatty acids. Cocamides are manufactured by condensation of alkanolamines (mono-, di-, or triethanolamine) and coconut fatty acid. Examples are cocamide MEA (cocamide monoethanolamine), cocamide DEA (cocamide diethanolamine) and cocamide TEA (cocamide triethanolamine). They have the physical and chemical characteristics of alcohols, amines and long carbon chains in one molecule.

This binder component of choice is available under many trade names/synonyms: coconut oil diethanolamine, coconut diethanolamide, Cocamide MEA, Comperlan 100 and Comperlan PD, (elromid KD 80—old trade name). There a similar products, like Cocamide DEA but these can be liquid. The liquid product is also acceptable, the extraction rate is faster but it can give green bodies of lower mechanical integrity. Its physical state and appearance is a semi-solid, lard-like fat at temperatures below 21° C. It is a hard brittle crystalline solid at temperatures below 15° C.

This particular SMFB component also features easy availability and low cost when purchased in large quantities and is environmentally safe. Some more additional features are also important: it does not leave any char residue. When dissolved into water it will increase the pH level (1% solution) to 8-10. This is important for certain systems like low-alloy steels as they become passivated ant there is no need to add any anti-rusting agent.

The preferred feedstock formulations and related preferred embodiments based on the dual binder concept according to this invention are applicable to essentially all powder systems:

1/ for water-extractable compositions, the relative fraction (total binder composition=100 vol %) of the SMFB component shall be 25 vol % or higher,
2/ for thermally evaporable compositions, the relative fraction should be 50 vol % or lower,
3/ for both water-extractable and evaporable compositions, the back-bone polymer content should be 5-10 vol % in general. This is though strongly dependent on the particle size. For very fine (submicron) powders the amount can be less (0-5 vol %), due to the contribution of inter-particle van der Vaals forces to the structural strength of the moulded parts. For coarser powder distributions, the addition range can be 10-30 vol %. The opposite applies to the amount of surfactants.

When thermal evaporative (item #2 above) procedure only is used, the debinding temperature-time profile is primarily a function of the three main parameters: the part geometry, the total furnace load and the load configuration/setting density. When running the system partially to fully loaded it is important to make sure that each part has sufficient room for access of heat and release of the volatilizing binder. As a rule, 5-10 mm between the parts is sufficient. The parts have to be placed on the support to prevent uneven heat distribution/shielding.

The evaporative debinding schedules for different powders (ceramics, metal, cermet) are quite similar. But, care has to be taken in the very critical initial stage of debinding, i.e. the stage of surface volatilization. In this stage, a small amount of binder is released from the surface/subsurface layer—thus making the surface stiffer (more high viscous) while opening up the porosity. This makes the surface of the part to contribute to the mechanical integrity of the of the part. The evaporative binder removal is very dependent on the 1^{st} temperature/time segment to avoid generation of internal overpressure (that can result in de-binding defects—pores, irregular voids, blisters or cracks). The critical temperature range for the binder system according to this invention is 50-200° C. A slow heat-up rate, in the range 0.25°/min is necessary to prevent defect formation at the start of the evaporative debinding run. The maximum primary evaporation temperature has to be low enough to prevent defect formation but high enough to produce sufficient primary binder removal to open up the porosity and to increase the intermittent strength of the part. In a preferred embodiment, not more than 15-35% of the total amount of binder shall be removed during the temperature/time segment in order to avoid risk of binder removal-related defect formation or a build-up of residual stresses.

It should be noted that the above-mentioned embodiments illustrate rather than limit the invention, and that those skilled in the art will be able to design many alternative embodiments without departing from the scope of these claims/embodiments. In the claims/embodiments, any reference signs placed between parentheses shall not be construed as limiting the claim. Use of the verb “comprise” and its conjugations does not exclude the presence of elements or steps other than those stated in a claim.

The article “a” or “an” preceding an element does not exclude the presence of a plurality of such elements. The mere fact that certain measures are recited in mutually different dependent claims does not indicate that a combination of these measures cannot be used to advantage.

1. A method of formulating dual binder for powder injection moulding of molded bodies characterized by using a primary main binder and secondary main multifunctional binder, the later simultaneously possessing the five (5) following functions: partially soluble in the primary binder, soluble in water, thermally evaporable, possessing a dispersant functionality towards the powder used and increasing the viscosity of the complete feedstock binder at near zero feedstock shear rate. In addition to these main binder components, the complete feedstock binder can optionally contain a small fraction of another dispersant and a back-bone polymer when needed, depending on the type of powder material used for the feedstock.

2. The method according to claim 1 wherein the meaning of “main” signifies that a content of the primary respectively second main binder is within the range of 20 to 80 vol %, each, of the total binder content.

3. The method according to claim 1 wherein the primary main binder is selected among high molecular weight hydrocarbon chain compounds such as paraffins, belonging to the group of alkanes, with all saturated bonds. Examples are pure paraffin-type wax, the melting index 54-62° C. but also mixtures or pure systems including bee wax, carnauba wax etc.

4. The method according to claim 1 wherein the secondary main binder is selected among long hydrocarbon chain non-ionic surfactants.

5. The method according to claim 4 wherein the secondary main binder is based on but not limited to cocamide diethanolamine, in particular, a commercial coconut fatty acid that has carbon chain composition of C10 (5% max)+C12 (45-55%)+C14 (20-25%)+C16 (10-15%)+C18 (10-15% max, including unsaturated fatty acids).

6. The method according to claim 4 wherein the secondary main binder is selected among compounds available under trade names and/or synonyms such as: coconut oil diethanolamine, coconut diethanolamide, Cocamide MEA, Cocamide DEA, Comperlan 100 and Comperlan PD, elromid KD 80 etc.

7. The method according to claim 4 wherein the selection includes any other compound that has the physical and chemical characteristics of alcohols, amines and long carbon chains in one molecule.

8. The method according to claim 1 wherein the secondary main binder is partially removed from molded bodies by exposure to water for 2 hours or longer.

9. The method according to claim 8 wherein the relative fraction of the secondary main binder (total binder composition=100 vol %) is 25 vol % or higher.

10. The method according to claim 1 wherein the secondary main binder is partially or completely removed from the molded bodies by evaporation up to approximately 300° C.

11. The method according to claim 10 wherein the relative fraction of the secondary main binder (total binder composition=100 vol %) is 50 vol % or lower.

12. The method according to claim 1 wherein the back-bone polymer content is 5-10 vol % in general but for very fine (submicron) powders 0-5 vol %.
